(19) United States
(12) Patent Application Publication
(10) Pub. No.: US 2011/0254382 A1
(43) Pub. Date: Oct. 20, 2011

(54) Monitoring and controlling electrical consumption

(76) Inventors: William Melendez, Mansfield, TX (US); Marshall Wenrich, Plano, TX (US); Mike Polcarl, Allen, TX (US)

(21) Appl. No.: 13/066,177

(22) Filed: Apr. 8, 2011

Related U.S. Application Data
(60) Provisional application No. 61/341,995, filed on Apr. 8, 2010.

(51) Int. Cl. H01H 47/00

(52) U.S. Cl. 307/126

(57) ABSTRACT

The invention provides a wall AC socket plug-in device for measuring electricity consumption of appliances and for controlling the alternating current power to said appliances. The invention uses an internal short-range mesh radio for continuously transmitting radio packets of the collected power usage to a collection device that logs and manages the data prior to sending it to an interne location.

### CLAIM OF PRIORITY

This Application claims priority to U.S. Provisional Patent Application No. 61/341,995 to common inventor Melendez, dated 8 Apr. 2010 and entitled Monitoring and Controlling Electrical Consumption.

### FIELD OF INVENTION

The present invention is in the field of instrumentation for measuring electricity and electrical signals.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Recently in the United States, there has been a movement towards more electrical efficiency and power conservation. Some appliances when connected, plugged in, to standard 110 and 220 electrical outlets may still use electricity even when the appliance is in a sleep mode. Appliances may still use electricity even when the appliance is not turned on. This bleeding of electricity wastes power and costs extra for owners.

Past developed outlets have dimmer switches or even timer switches which turn the power off after a certain predetermined amount of time or reduce the amount of power flowing to the appliance. These past devices did not have monitoring capabilities or refined control abilities. An owner would have to manually operate the control timing switch or diming switch limiting the conservation abilities and creating extra work. Using the timing device requires manual adjustment each time it is used.

Current power monitoring devices limit how the user interacts with the devices and lack any programmable capabilities. What is programmable electrical outlet monitoring and controlling apparatus, and the invention provides such.

### BRIEF DESCRIPTION OF THE DRAWINGS

Various aspects of the invention, as well as an embodiment, are better understood by reference to the following detailed description. To better understand the invention, the detailed description should be read in conjunction with the drawings and tables, in which:

FIG. 1 shows the view inside of the casing of the monitoring and controlling electrical consumption apparatus.

FIG. 2 shows the view of the monitoring and controlling electrical consumption system and its components.

FIG. 3 shows the top front view of the monitoring and controlling electrical consumption apparatus.

FIG. 4 shows the top rear view of the monitoring and controlling electrical consumption apparatus.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

As will be understood by those of ordinary skill in the art, various structures and devices are depicted in block diagram form in order to avoid unnecessarily obscuring the invention. As used, herein and the accompanying drawings, B12 refers to positive 12 volts, and N12 refers to negative 12 volts. Additionally the term “set” refers to the application of 12 volts (B12), while the term “reset” refers to the removal of 12 volts.

Some methods of the invention may be practiced by placing the invention on a computer-readable medium, particularly the control and detection/feedback methodologies. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to operate the methods of the invention. It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise.

### DESCRIPTION OF THE DRAWINGS

The present invention is a monitoring and controlling electrical consumption apparatus. The apparatus monitors and collects appliance electricity consumption data through the use of individual alternating current measuring and monitoring devices collectively labeled as power monitors located with each appliance, either as a straight plug-in unit or as a wall AC receptacle unit. The system exercises remote command and control of each appliance by sending an RF signal that the power monitor's internal microcontroller interprets to turn the appliance AC power source either on or off. Each power monitor transmits its measurements of the appliance electricity to a network system's node controller gateway. The node controller gateway collects the data and stores it within its database for further analysis and configuring.

A power metering and control device designed to meter and collect appliance electricity consumption data through the use of individual alternating current, AC, measuring of voltage/current to derive appliance power use and microcontroller circuitry for processing such measurements collectively labeled as power meter which transmits via radio frequency continuous usage data and status of appliances to a singular data collection point called a node controller gateway. Said device measures electricity used by an appliance plugged into its AC receptacle and provides a means of remotely turning an appliance on or off as needed.

That said device has unique circuits that result in a design to minimize space so as to have the look and feel of a standard wall receptacle while maintaining the measuring capacity of a commercial watt hour meter. The combined circuitry and PCB layout design gives this product its unique size and capacity to both measure electricity and to control electricity flow to an appliance. The metering capacity was achieved utilizing a single processor and radio-processor combination utilizing a unique propriety coding scheme.

The internal microcontroller has unique firmware code designed to interpret the readings received and process them to the internal two-way radio module for transmitting to the node controller gateway. Microcontroller, uController, receives the on or off command from the node controller gateway to disconnect or connect an appliance from its AC power source.

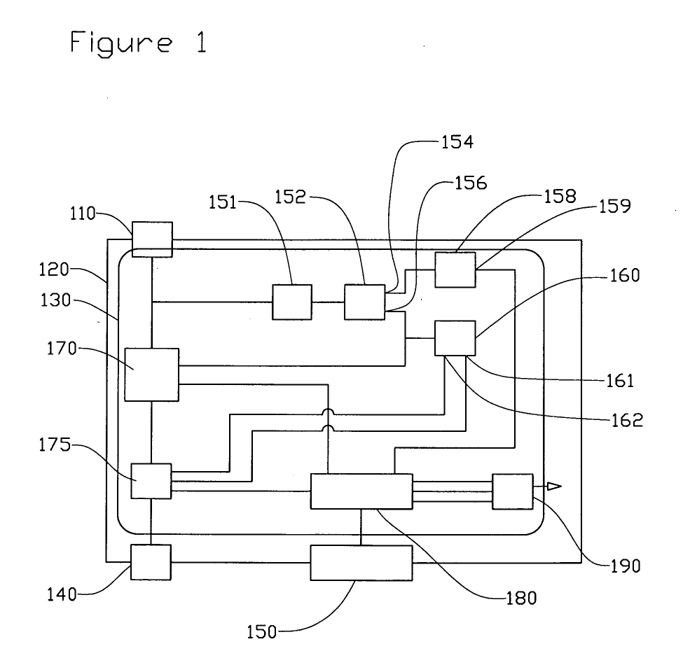

Shown in FIG. 1 is the inside the casing view of the monitoring and controlling electrical consumption apparatus. The plug 110 couples to a regular 120 VAC standard outlet and is used to power the apparatus and the receptacle 140. A direct electronic source is a sufficient replacement for the plug 110 and a standard AC receptacle. The plug 110 is fitted into the outside wall of the casing 120 which holds the circuit board 130, the 120 VAC receptacle 140, and the development header 150 in fixed positions for support. The 120 VAC plug 110 is coupled to a fuse 151 which is coupled to a AC to DC converter 152. The AC to DC converter 152 reduces the 120 VAC it receives from the plug 110 to two separate smaller outputs, a 8.0 VDC output 154 and a 5.0 VDC output 156. A first DC to DC converter 158 which couples to the AC to DC converter 152 at the 8.0 VDC output 154. The first DC to DC converter 158 reduces the 8.0 VDC it receives to 3.3 VDC at the 3.3 VDC output. A second DC to DC converter 160 couples to the AC to DC converter 152 at the 5.0 VDC output 156. The second DC to DC converter 160 reduces the 5.0 VDC it receives to a first 2.5 VDC output 161 and a second 2.5 VDC output 162. A relay 170 is coupled to the first DC to DC converter at the 5.0 VDC output 156. The relay 170 is coupled to the 120 VAC plug 110 and where the relay 170 transfers that current from the plug to the power measurement unit 175. The relay 170 is the on/off switch for the 120 VAC. The relay 170 is coupled to the uController 180. The relay 170 receives the instruction for on or off from the uController 180. The couple between the relay 170 and the uController 180 is a digital 1 bit connection. The uController 180 sends a 1 bit message to the relay 170 which instructs the relay 170 to disconnect the 120 VAC power or to reconnect the power. The power measurement unit 175 is coupled to the second DC to DC converter 160 at the first 2.5 VDC output 161 and the second 2.5 VDC output 162. The power measurement unit 175 measures the current traveling from the relay 170 to the 120 VAC receptacle 140. The power measurement unit 175 sends a power tick, 1 bit, signal to the uController 180. The power measurement unit 175 monitors the power usage of any device plugged into the receptacle 140, and reports this data to the uController 180 via a series of ticks. The uController 180 measures the amount of voltage by the amount of ticks. The power measurement unit 175 is couples the relay 175 to the 120 VAC receptacle 140.

The uController 180 is coupled to a development header 150. The uController 180 sends power monitoring data to the development header 150. The development header 150 debugs and programs the uController 180. A radio 190 is coupled to the uController 180. The uController 180 controls the system. It receives and interprets the tick data from the power measurement unit 175, controls and configures the radio 190 function, receives and sends power data to the radio 190, controls the power to the AC receptacle 140 via the relay 170.

The radio 190 can send and receive information with an outside apparatus. The SemTech® XE 1203 radio or a standard RF radio are suitable for this apparatus. The apparatus can operate without the radio 190 and all the programming goes directly through the development header 150. The development header 150 acts as a interface for separate radio modules that are used as a replacement for the onboard radio module.

When an appliance is plugged into the receptacle 140, this allows the apparatus to monitor and control the appliance's power usage as well as turn the power on and off to the appliance.

An adapted apparatus monitors and controls a 240 VAC source as well. The 240 VAC version would have the 240 plug, which is 110 in FIG. 1 and would have the 240 VAC receptacle, which is 140 in FIG. 1.

The invention provides the continuous measurement of power usage for a specific A/C outlet accumulated over time and periodically transmitted (for example, every 1/10, 1, 5, 10, or 30 seconds) to a plug gateway receiver for further data concatenation in such a way that it allows subsequent evaluation for usage trends during time periods within the day and over several days. The apparatus also has a control to disable the outlet power via a command issued via an internet-enabled device through a gateway node, and another command to enable outlet power such that the outlet control can be externally programmed to automatically turn on and off at certain time intervals during the day. Wireless networks are well known in the art, and the invention may incorporate any wireless network known or developed in the art.

Exemplary wireless layers include an OpenRF or ZigBeem, for example. The circuit design preferably accommodates a PCB radio in the layout, or a plug-in radio module connected with a serial port to the monitoring and control circuit. Power for the monitoring and radio is taken from the A/C line itself by converting the A/C to 5-8 VDC. The apparatus preferably consumes less than one (1) Watt of power on average during operation.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application.

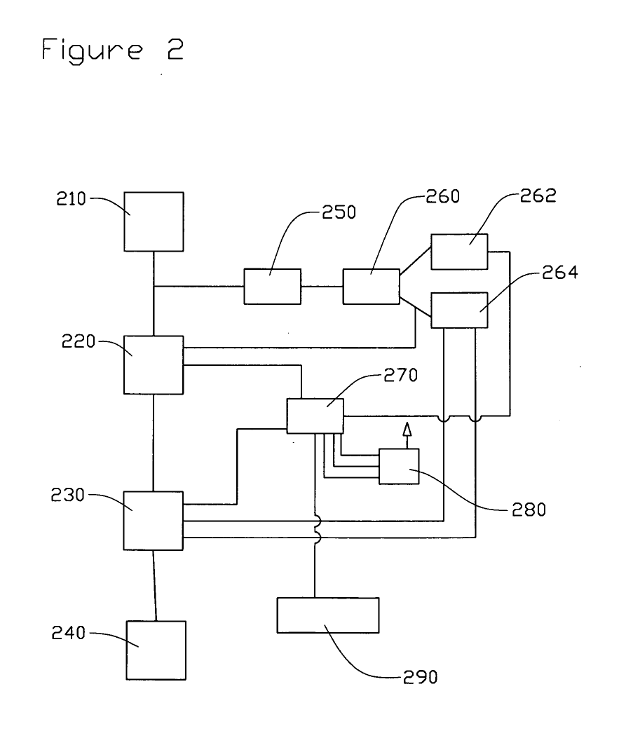

The monitoring and controlling electrical consumption system is shown in FIG. 2. The electrical source 210 is any power source that provides adequate power to operate an appliance. The source 210 is coupled to a relay 220. The relay disconnects the power source 210 or reconnects the power source 210 to the power measurement unit 230. The power measurement unit measures power usage transferred from the relay 220 to the receptacle 240. A fuse 250 is coupled to the power source 210 before the relay 220. The fuse 250 operates to reduce the chance of short circuiting the system. The 250 fuse is coupled to an AC to DC converter 260 which reduces the amount of power from the source 210 to the rest of the controlling and monitoring system. The relay 220 is coupled to the AC to DC converter. The uController 270 is coupled to the AC to DC converter 260 via a first DC to DC converter 262. The first DC to DC converter 262 reduces the amount of power received from the AC to DC converter 260 to send to the uController 270. The power measurement unit 230 is coupled to the AC to DC converter 260 via the second DC to DC converter 264. The second DC to DC converter 264 reduces power received from the AC to DC converter 260 and transfers the current to the power measurement unit 230. A radio 280 is coupled to the uController 270. The radio 280 sends power monitoring data and receives data from an outside source, such as a computer or web base application, to debug and program the uController 270. The uController 270 is coupled to a development header 290. The development header 290 debugs and programs the uController 270. The development header 290 also operates as an interface in the absence of a radio 280. The system can operate with or without the radio 280.

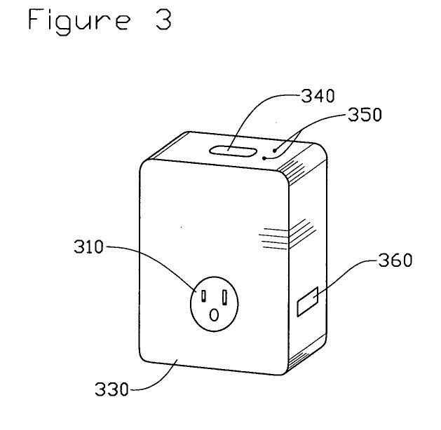

Shown in FIG. 3 is the top front view of dual outlet version of the apparatus. This electrical monitoring and controlling apparatus plugs into two outlets located together and has two receptacles and monitors and controls each receptacle individually. The dual outlet apparatus monitors and controls two appliances respectively. The power source is a standard house outlet that can be hard wired into the apparatus or the apparatus can have two plugs and plug into a standard outlet. The power source is an electrical source such as a 120 VAC or 240 VAC.

The apparatus has a first receptacle 310. An appliance can be plugged into the receptacle 310 and be monitored and controlled accordingly. The casing 330 secures the receptacle 310 and the development header 340. The development header 340 has a screen output readable for monitoring power usage data and programming capabilities to control the power usage of the receptacle 310. The development header control buttons 350 are used for programming and debugging the apparatus. In FIG. 3, the apparatus has the female end to a modular connector 360. The modular connector 360 couples to the uController (not shown in FIG. 3, but understood by those of ordinary skill in the art) and allows the uController to be debugged and programmed from an outside source such as a computer or a web based application. The uController can also report data to through the modular connector 360 to an outside receiver such as a computer or a web based application.

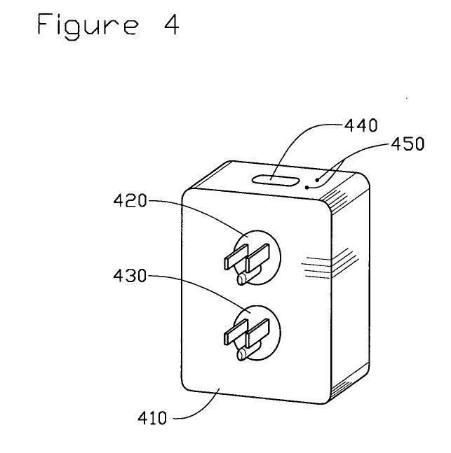

Show in FIG. 4 is the top rear view of the monitoring and controlling electrical consumption apparatus. The casing 410 secures the first plug 420 and the second plug 430. The development header 440 is secured by the casing 410 as well. The programming buttons 450 are used to control the development header 440.

We claim:

1. An apparatus for monitoring and controlling electronic devices by controlling power outlets comprising:
a 120 VAC plug;
a Fuse coupled between the 120 VAC plug, and the AC to DC converter by 120 the
120 VAC lines, the AC to DC converter converts 120 VAC to one 8 VDC output and one 5 VDC output;
a first DC to DC converter coupled to the AC to DC converter at the 8.0 VDC output, the
first DC to DC converter drops the voltage from an 8 VDC input to a 3.3 VDC output;
a second DC to DC converter coupled to the AC to DC converter at the 3.3 VDC output, the second DC to DC converter splits the 5.0 VDC input into two individual 2.5 VDC outputs;
a uController coupled to the first DC to DC converter at the 3.3 VDC output, the
uController sends an digital, 1 bit, the uController is coupled power measurement unit at the power tick, 1 bit, output, the uController has a JT AG input and output and the uController has a serial data, SPI command, and power setting message outputs;
a relay coupled to the 120 VAC plug, the AC to DC converter at the 5.0 VDC output and
the uController at the digital, 1 bit output, the relay has a 120 VAC output;
a power measurement unit coupled to the second DC to DC converter at the two 2.5 VDC
outputs, coupled to the Relay at the 120 VAC output, coupled to the uController by the power measurement unit's power tick, 1 bit output, the power measurement unit has a 120 VAC output;
a 120 VAC receptacle coupled to the power measurement unit at the 120 VAC output;
a circuit board which affixes the fuse, AC to DC converter, the first DC to DC converter, the second DC to DC converter, the Relay, the Power Measurement Unit, and the uController;
a development header coupled to the uController by the JT AG output and input;
a casing enclosing the circuit board and affixed features and lines with a first opening to fit the 120 VAC plug and allows outside access to the plug, has a second opening on the opposite side that fits the 120 VAC Receptacle allowing outside access to the Receptacle, and a third opening that fits the Development Header allowing the Header to be viewable from outside the casing;
the uController is for receiving and interpreting tick data from the power measurement unit, and for sending power data to the development header, and for controlling the power to the 120 VAC receptacle via the Relay,
the Development Header is for programming and debugging the uController and for receiving and displaying power data from the uController,
the 120 VAC Plug is the mechanical connection that plugs into a standard wall electrical outlet to deliver power flow through the apparatus and to the AC receptacle,
the Relay functions as the power switch to turn power on and off to the receptacle,
the Power Measurement Unit is for monitoring the power usage of any device plugged into the receptacle, and for reporting the data to the uController.

2. The apparatus in claim 1 wherein a radio is coupled to the first DC to DC converter at the 3.3 VDC output and is coupled to the uController at the serial data, SPI command, and power setting message outputs.

3. The apparatus in claim 2 wherein the radio is a RF radio.

4. The apparatus in claim 2 wherein the radio is a SemTech® 1203.

5. The apparatus in claim 2 wherein the radio is web-enabled.

6. The apparatus in claim 1 wherein the development header has a coupler allowing the device to be coupled to an outside data line.

7. The apparatus in claim 6 wherein the coupler is a modular connector.

8. The apparatus in claim 7 wherein the modular connector is a 4P4C connector.

9. The apparatus in claim 7 wherein the modular connector is a 8P8C connector.

10. An apparatus for monitoring and controlling electronic devices by controlling power outlets comprising:
a 240 VAC plug;
a Fuse coupled between the 240 VAC plug, and the AC to DC converter by 240 the
240 VAC lines, the AC to DC converter converts 240 VAC to one 8 VDC output and one 5 VDC output;
a first DC to DC converter coupled to the AC to DC converter at the 8.0 VDC output, the
first DC to DC converter drops the voltage from an 8 VDC input to a 3.3 VDC output;
a second DC to DC converter coupled to the AC to DC converter at the 3.3 VDC output, the second DC to DC converter splits the 5.0 VDC input into two individual 2.5 VDC outputs;
a uController coupled to the first DC to DC converter at the 3.3 VDC output, the
uController sends an digital, 1 bit, the uController is coupled power measurement unit at the power tick, 1 bit, output, the uController has a JT AG input and output and the uController has a serial data, SPI command, and power setting message outputs;
a relay coupled to the 240 VAC plug, the AC to DC converter at the 5.0 VDC output and
the uController at the digital, 1 bit output, the relay has a 240 VAC output;
a power measurement unit coupled to the second DC to DC converter at the two 2.5 VDC
outputs, coupled to the Relay at the 240 VAC output, coupled to the uController by the power measurement unit's power tick, 1 bit output, the power measurement unit has a 240 VAC output;
a 240 VAC receptacle coupled to the power measurement unit at the 240 VAC output;
a circuit board which affixes the fuse, AC to DC converter, the first DC to DC converter, the second DC to DC converter, the Relay, the Power Measurement Unit, and the uController;
a development header coupled to the uController by the JT AG output and input;
a casing enclosing the circuit board and affixed features and lines with a first opening to fit the 240 VAC plug and allows outside access to the plug, has a second opening on the opposite side that fits the 240 VAC Receptacle allowing outside access to the Receptacle, and a third opening that fits the Development Header allowing the Header to be viewable from outside the casing;
the uController is for receiving and interpreting tick data from the power measurement unit, and for sending power data to the development header, and for controlling the power to the 240 VAC receptacle via the Relay,
the Development Header is for programming and debugging the uController and for receiving and displaying power data from the uController,
the 240 VAC Plug is the mechanical connection that plugs into a standard wall electrical outlet to deliver power flow through the apparatus and to the AC receptacle,
the Relay functions as the power switch to turn power on and off to the receptacle,
the Power Measurement Unit is for monitoring the power usage of any device plugged into the receptacle, and for reporting the data to the uController.

11. The apparatus in claim 10 wherein a radio is coupled to the first DC to DC converter at the 3.3 VDC output and is coupled to the uController at the serial data, SPI command, and power setting message outputs.

12. The apparatus in claim 12 wherein the radio is a RF radio.

13. The apparatus in claim 12 wherein the radio is a SemTech® 1203.

14. The apparatus in claim 12 wherein the radio is web-enabled.

15. The apparatus in claim 11 wherein the development header has a coupler allowing the device to be coupled to an outside data line.

16. The apparatus in claim 15 wherein the coupler is a modular connector.

17. The apparatus in claim 16 wherein the modular connector is a 4P4C connector.

18. The apparatus in claim 16 wherein the modular connector is a 8P8C connector.

19. A system for monitoring and controlling electronic devices by controlling power outlets comprising:
an electrical source;
a Fuse coupled between the electrical source and an AC to DC converter, the AC to DC converter reduces current from the source and transmits the reduced current to a first output and a second output;
a first DC to DC converter coupled to the AC to DC converter at the first output, the first DC to DC converter reduces the current from the AC to DC converter and transmits the reduced current at output;
a second DC to DC converter coupled to the AC to DC converter at the second output, the second DC to DC converter splits the received current an outputs;
a uController coupled to the first DC to DC converter receiving the reduced current, the uController sends an digital, 1 bit signal to the relay, the uController is coupled power measurement unit at the power tick, 1 bit, output, the uController has a JT AG input and output and the uController has a serial data, SPI command, and power setting message outputs;
a relay coupled to the the AC to DC converter at the second output and coupled to the uController at the digital, 1 bit output, the relay has a transmits the current it receives from the electrical source to a power measurement unit;
a power measurement unit coupled to the second DC to DC converter, coupled to the Relay, and coupled to the uController by the power measurement unit's power tick, 1 bit output, the power measurement unit has a transmits the current it receives from the relay to the system's electrical output for appliance usage;
a development header coupled to the uController by the JT AG output and input;
the uController is for receiving and interpreting tick data from the power measurement unit, and for sending power data to the development header, and for controlling the power to the system output via the Relay,
the Development Header is for programming and debugging the uController and for receiving and displaying power data from the uController,
the electrical source is the mechanically connected to the system to deliver power flow through the apparatus and to the system output to an appliance,
the Relay functions as the power switch to turn power on and off to the output,
the Power Measurement Unit is for monitoring the power usage of any device connected to the system, and for reporting the data to the uController.
